(19) United States
(12) Patent Application Publication
(10) Pub. No.: US 2023/0222858 A1
(43) Pub. Date: Jul. 13, 2023

(54) SYSTEMS AND METHODS FOR ACTIVATING A DIGITAL KEY BASED ON A VITAL SIGN

(71) Applicant: Toyota Motor Engineering & Manufacturing North America, Inc., Plano, TX (US)

(72) Inventor: Katsumi Nagata, Foster City, CA (US)

(21) Appl. No.: 17/572,466

(22) Filed: Jan. 10, 2022

(51) Int. Cl. G07C 9/26; G07C 9/28; G07C 9/29; G07C 9/00

(52) U.S. Cl. CPC G07C 9/26; G07C 9/28; G07C 9/29; G07C 9/00309; G07C 2009/00769

(57) ABSTRACT

Systems and methods for activating a digital key based on a vital sign include the digital key configured to lock and unlock a digital lock when activated. The system may include an electronic device including a sensor configured to detect a vital sign of a user in real time. The electronic device may include a memory configured to store a reference vital sign of the user. The electronic device may include a wireless transceiver configured to communicate with the digital key. The electronic device may include a processor coupled to the sensor, the memory, and the wireless transceiver. The processor may be configured to receive and compare the vital sign to the reference vital sign and prompt the wireless transceiver to send a signal to the digital key to activate the digital key when the vital sign is within a threshold of similarity to the reference vital sign.

### BACKGROUND

### 1. Field

The present disclosure is directed to digital security systems, particularly systems and methods for activating a digital key to unlock a digital lock based on a vital sign.

### 2. Description of the Related Art

Digital security systems including digital keys and digital locks are becoming more widespread. For example, vehicles (e.g., automobiles, motorcycles, trucks, motorhomes, boats, airplanes, etc.), homes, and hotel rooms have been increasingly utilizing digital locks that are unlocked with digital keys to control access. Some digital keys even have the capability to unlock multiple digital locks, each digital lock providing a different access. Digital keys are often integrated into portable electronic devices, such as smartphones. As such, digital keys are generally accessible when smartphones integrating them are unlocked by their users. Smartphones are increasingly unlocked by providing biometric information, such as a fingerprint or a facial scan. In certain situations, one can obtain such biometric information or bypass user authentication without the consent of the user of a smartphone to unlock the smartphone and have access to the digital key. Further, some smartphones allow for the digital key to be activated without unlocking the smartphone or another type of user authentication to speed up the unlocking process. Hence, digital keys have security deficiencies.

As such, there is a need for systems and methods for activating a digital key based on a vital sign.

### SUMMARY

Examples described herein relate to embodiments of digital security systems and methods for operating the same. A digital security system may include a digital key that may lock and unlock a digital lock when activated. The digital security system may further include an electronic device. The electronic device may have a sensor, a memory, a wireless transceiver, and a processor. The sensor may detect or measure a vital sign (e.g., pulse rate, respiration rate, body temperature, etc.) of a user in real time. The processor may receive the vital sign from the sensor and compare the vital sign to a reference vital sign stored in the memory. When the vital sign is within a threshold of similarity to the reference vital sign, the processor may prompt the wireless transceiver to communicate with the digital key to activate the digital key. Additionally, when the vital sign is not within the threshold of similarity to the reference vital sign or not detected or measured, the processor may prompt the wireless transceiver to communicate with the digital key to deactivate the digital key.

In one aspect, the disclosure is embodied in a digital security system. The digital security system includes a digital key configured to lock and unlock a digital lock when activated. The digital security system further includes an electronic device. The electronic device includes one or more sensors configured to detect or measure one or more vital signs of a user in real time. The electronic device further includes a memory configured to store one or more reference vital signs of the user. The electronic device further includes a wireless transceiver configured to communicate with the digital key. The electronic device further includes a processor coupled to the one or more sensors, the memory, and the wireless transceiver. The processor is configured to receive the one or more vital signs from the one or more sensors. The processor is further configured to compare the one or more vital signs to the one or more reference vital signs. The processor is further configured to prompt the wireless transceiver to send a signal to the digital key to activate the digital key when the one or more vital signs are within a threshold of similarity to the one or more reference vital signs. The processor is further configured to deactivate the digital key when the one or more vital signs are not within the threshold of similarity to the one or more reference vital signs or not detected or measured.

These and other embodiments may optionally include one or more of the following features. The digital lock may be a lock of a vehicle. The digital lock may lock and unlock one or more doors of the vehicle and enable a power source of the vehicle to supply power to the vehicle when activated. The power source may be disabled when the digital key is activated. The vehicle may be an autonomous vehicle having an electronic control unit (ECU). The ECU may be configured to automatically control the power source and brakes of the vehicle to pull over the vehicle and disable the power source once the vehicle is pulled over when the digital key is deactivated.

The processor may be further configured to prompt user authentication information and choose the reference one or more vital signs from the memory to compare to the one or more vital signs based on user identification data stored in the memory that are associated with the user authentication information. The wireless transceiver may be further configured to transmit the user identification data to the digital key. A processor of the digital key may be configured to verify the user identification data by comparing the user identification data to a reference user identification data stored in a memory of the digital key prior to the digital key unlocking the digital lock. Alternatively, a processor of the digital key may be configured to prompt and verify user authentication information prior to the digital key unlocking the digital lock.

In another aspect, the disclosure is embodied in a digital security system for a vehicle. The digital security system includes a digital key. The digital key is configured to lock and unlock a digital lock for one or more doors of the vehicle and enable a power source of the vehicle to supply power to the vehicle when activated and disable the power source when deactivated. The digital security system further includes a wearable electronic device. The wearable electronic device includes one or more sensors configured to detect or measure one or more vital signs of a user in real time. The wearable electronic device further includes a memory configured to store one or more reference vital signs of the user. The wearable electronic device further includes a wireless transceiver configured to communicate with the digital key. The wearable electronic device further includes a processor coupled to the one or more sensors, the memory, and the wireless transceiver. The processor is configured to receive the one or more vital signs from the one or more sensors. The processor is further configured to compare the one or more vital signs to the one or more reference vital signs. The processor is further configured to prompt the wireless transceiver to send a signal to the digital key to activate the digital key when the one or more vital signs are within a threshold of similarity to the one or more reference vital signs and deactivate the digital key when the one or more vital signs are not within the threshold of similarity to the one or more reference vital signs or not detected or measured.

These and other embodiments may optionally include one or more of the following features. The one or more vital signs of the user may include a pulse rate, a respiration rate, and a body temperature. The wearable electronic device may be configured to be worn on a wrist of the user. The vehicle may be an autonomous vehicle having an ECU. The ECU may be configured to automatically control the power source and brakes of the vehicle to pull over the vehicle and disable the power source once the vehicle is pulled over when the digital key is deactivated. The processor may be further configured to prompt user authentication information and choose the reference one or more vital signs from the memory to compare to the one or more vital signs based on user identification data stored in the memory that are associated with the user authentication information. The wireless transceiver may be further configured to transmit the user identification data to the digital key. A processor of the digital key may be configured to verify the user identification data by comparing the user identification data to a reference user identification data stored in a memory of the digital key prior to the digital key unlocking the digital lock. Alternatively, a processor of the digital key may be configured to prompt and verify user authentication information prior to the digital key unlocking the digital lock.

In yet another aspect, the disclosure is embodied in a method for operating a digital security system. The method includes one or more sensors of an electronic device detecting or measuring one or more vital signs of a user in real time. The method further includes a processor of the electronic device receiving the one or more vital signs from the one or more sensors. The method further includes the processor of the electronic device comparing the one or more vital signs to one or more reference vital signs of the user stored in a memory of the electronic device. The method further includes a wireless transceiver of the electronic device sending a first signal to a digital key to activate the digital key when the one or more vital signs are within a threshold of similarity to the one or more reference vital signs. The method further includes the digital key unlocking a digital lock when the digital key is activated. The method further includes the wireless transceiver of the electronic device sending a second signal to the digital key to deactivate the digital key when the one or more vital signs are not within the threshold of similarity to the one or more reference vital signs or not detected or measured.

These and other embodiments may optionally include one or more of the following features. The digital lock may be a lock of a vehicle that locks and unlocks one or more doors of the vehicle. The method may further include an ECU of the vehicle enabling a power source of the vehicle to supply power to the vehicle when the digital lock is activated. The method may further include the ECU of the vehicle disabling the power source when the digital key is activated.

The vehicle may be an autonomous vehicle. The ECU of the vehicle may automatically control the power source and brakes of the vehicle to pull over the vehicle when the digital key is deactivated. The ECU of the vehicle may disable the power source once the vehicle is pulled over.

The method may further include the wireless transceiver of the electronic device transmitting the user identification data to the digital key. The method may further include a processor of the digital key verifying the user identification data by comparing the user identification data to a reference user identification data stored in a memory of the digital key prior to the digital key unlocking the digital lock.

The method may include a processor of the digital key prompting user authentication information. The method may further include the processor of the digital key verifying the user authentication information prior to the digital key unlocking the digital lock.

### BRIEF DESCRIPTION OF THE DRAWINGS

Other systems, methods, features, and advantages of the present disclosure will be apparent to one skilled in the art upon examination of the following figures and detailed description. Component parts shown in the drawings are not necessarily to scale and may be exaggerated to better illustrate the important features of the present disclosure.

FIG. 1 shows a schematic view of a digital security system according to an aspect of the present disclosure;

FIG. 2 shows a user interacting with a digital security system of a vehicle according to an aspect of the present disclosure;

FIG. 3 shows a schematic view of the vehicle of FIG. 2 according to an aspect of the present disclosure;

FIG. 4 shows a schematic view of a user input/output device of an electronic device of a digital security system according to an aspect of the present disclosure;

FIG. 5A shows a schematic view of an example user authentication process of a digital security system according to an aspect of the present disclosure;

FIG. 5B shows a schematic view of another example user authentication process of a digital security system according to an aspect of the present disclosure; and

FIG. 6 shows a flowchart of a method for operating a digital security system according to an aspect of the present disclosure.

### DETAILED DESCRIPTION

The digital security systems and methods described herein activate a digital key based on a vital sign to unlock a digital lock. The digital security systems and methods may utilize an electronic device to activate the digital key. The electronic device may advantageously prevent the digital key from being used to unlock the digital lock when a user of the electronic device changes without authorization of the original user, when the electronic device is disabled or tampered with, or when the digital key is stolen and the security measures of the digital key, if any, are bypassed. The electronic device may be a wearable device (e.g., a watch, a bracelet, a wrist/arm band, a ring, etc.). The electronic device may include a sensor, a memory, a wireless transceiver, and a processor. The sensor may detect or measure a vital sign (e.g., a pulse rate, a respiration rate, a body temperature, etc.) of the user in real time. The processor may receive the vital sign from the sensor. Then, the processor may compare the vital sign to a reference vital sign stored in the memory. The processor may prompt the wireless transceiver to communicate with the digital key to activate the digital key when the vital sign is within a threshold of similarity to the reference vital sign. Conversely, the processor may prompt the wireless transceiver to communicate with the digital key to deactivate the digital key when the vital sign is not within a threshold of similarity to the reference vital sign or is not detected or measured.

The digital security systems and methods may be advantageously implemented in vehicles (e.g., automobiles, motorcycles, trucks, motorhomes, boats, airplanes, etc.). In such embodiments, the term “user” or “driver” may be interchanged with “passenger” when referring to autonomous or semi-autonomous vehicles. Also, in such embodiments, the digital key may unlock doors of the vehicle as well as start the vehicle in preparation to be driven. If the digital key is deactivated, the vehicle may be prevented from being driven. In autonomous vehicles, an ECU of the vehicle may automatically and safely pull over the vehicle when the digital key is deactivated. In addition to providing heightened security, this feature may be further advantageous in situations where the electronic device detects or measures an abnormal vital sign from the original user, which may indicate that the user is incapacitated, intoxicated, impaired, unconscious, distressed, or has no pulse behind the wheel of the vehicle.

The electronic device may store multiple user profiles, each user profile including reference vital signs of a unique user. To enhance the accuracy, the electronic device may utilize more than one vital sign. The electronic device may recall a stored user profile based on inputted user authentication information (e.g., a password, a passcode, a biometric scan) associated with that user profile. The electronic device may be recognized and authenticated by the digital key by transmitting user identification data associated with the user authentication information to the digital key before the digital key can be activated. Alternatively, the digital key may prompt and verify user authentication information before the digital key can be activated. Once the electronic device and the digital key are paired, any additional latency or delay during each digital key activation may be advantageously avoided since the electronic device detects or measures and processes vital signs continuously in real time. When a wearable electronic device is unworn or taken off, the electronic device and the digital key may be unpaired and the pairing process may have to be repeated as an additional security layer to reauthenticate the user.

Further, the digital key may be paired with multiple electronic devices. Hence, the digital key may have multiple authorized users and authorized user may have multiple electronic devices to choose from to activate the digital key. Additionally, multiple digital keys may be paired with the digital lock to lock and unlock the digital lock.

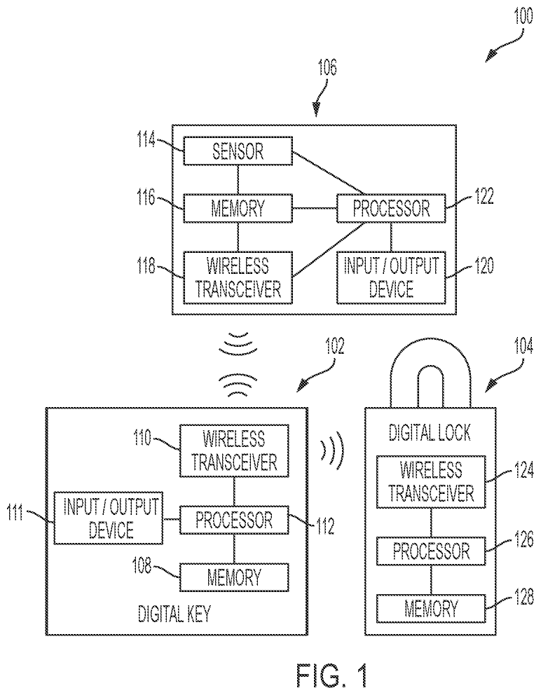

FIG. 1 shows a schematic view of a digital security system 100. The digital security system 100 may include a digital key 102, a digital lock 104, and an electronic device 106.

The digital key 102 may be a portable device. For example, the digital key 102 may be a mobile phone, a tablet device, a laptop computer, a key fob, a clicker, an access card, a vehicle key, a portable multimedia player, a portable gaming device, and any other portable and electro-mechanical device. The digital key 102 may be shaped, sized, and weighed to be held and transported with ease. For example, the digital key 102 may fit into a pocket. The digital key 102 may include a memory 108, a wireless transceiver 110, an input/output device 111, and a processor 112.

The memory 108 may be a random-access memory (RAM), a disk, a flash memory, optical disk drives, hybrid memory, or any other store medium that can store data. The memory 108 may store program code that is executable by the processor 112. The memory 108 may store data in an encrypted or any other suitable secure form. In some embodiments, the digital key 102 may retrieve data from a server or multiple servers via an Internet connection instead of or in addition to the memory 108. In some embodiments, a remote server may be used to store data in lieu of or in addition to the memory 108.

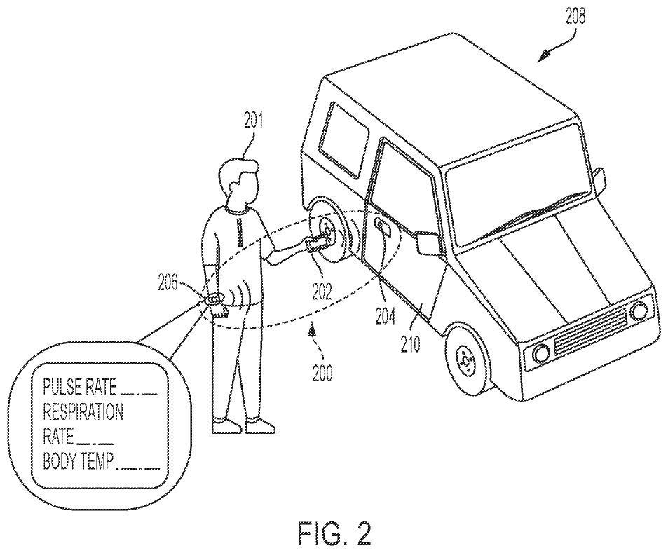

The wireless transceiver 110 may include but not be limited to a Bluetooth®, an infrared (IR), a radio frequency (RF), an ultra-wide band (UWB), or a WiFi® based communication hardware. In some embodiments, some or all of the aforementioned communication methods may be available for selection of a user 201 (see FIG. 2) based on preference or suitability (e.g., signal travel distance, signal availability, signal interference, signal travel speed, etc.). The wireless transceiver 110 may utilize another wireless communication technology appreciated by one of ordinary skill in the art.

The processor 112 may be configured to execute machine-readable instructions. In some embodiments, there may be one or more processors or microprocessors. In some embodiments, the processor 112 may be a part of a controller or a microcontroller comprising one or more integrated circuits configured to control and manage operations of the digital key 102.

The input/output device 111 may receive visual, auditory, and/or touch input. For example, the input/output device 111 may include a camera, a microphone, a touchscreen, a button, and/or a remote. The user 201 (see FIG. 2) may input commands and information into the input/output device 111 to operate the digital key 102. For example, the input/output device 111 may receive biometric information, voice commands, and/or touch inputs with one or more fingers. The input/output device 111 may further output information, such as notifications, through visual, auditory, and/or haptic means. For example, the input/output device 111 may include a display, which may be a touchscreen display, a speaker, and/or a vibration motor. The user 201 may receive information visually through the display, auditorily through the speaker, and/or haptically through the vibration motor. The input/output device 111 may request and accept user authentication information prior to the digital key 102 unlocking the digital lock 104.

The display of the input/output device 111 may be a liquid crystal display (LCD), a light-emitting diode display (LED), an organic light emitting diode (OLED), a plasma display, a cathode-ray tube (CRT) display, a digital light processing display (DLPT), a microdisplay, a projection display, or any other display appreciated by one of ordinary skill in the art. The display may display user interfaces, text, images, and/or the like.

The digital lock 104 may be any electronic, mechanical, or electromechanical machine, structure, device, and/or the like that bars, controls, observes, and/or regulates entry or access to a point beyond it. The term “digital lock” may be replaced with “access control system” and/or “access control device” throughout this disclosure. By way of example and not limitation, the digital lock 104 may be a door lock, a vehicle lock, a mailbox lock, a delivery locker lock, a security gate, or a ticket checkpoint (e.g., public transportation, movies, shows, sporting events, etc.). The digital lock 104 may include a wireless transceiver 124, a processor 126, and a memory 128.

The wireless transceiver 124 may wirelessly exchange information with the digital key 102. The wireless transceiver 124 may include but is not limited to a Bluetooth®, an IR, an RF, an UWB, or a WiFi® based communication hardware. In some embodiments, some or all of the aforementioned communication methods may be available for selection of the user 201 (see FIG. 2) based on preference or suitability (e.g., signal travel distance, signal availability, signal interference, signal travel speed, etc.). The wireless transceiver 124 may utilize another wireless communication technology appreciated by one of ordinary skill in the art.

The processor 126 may be configured to execute machine-readable instructions. In some embodiments, there may be one or more processors or microprocessors. In some embodiments, the processor 126 may be a part of a controller or a microcontroller comprising one or more integrated circuits configured to control and manage operations of the digital lock 104.

The memory 128 may be a random-access memory (RAM), a disk, a flash memory, optical disk drives, hybrid memory, or any other store medium that can store data. The memory 128 may store program code that is executable by the processor 126. The memory 128 may store data in an encrypted or any other suitable secure form. In some embodiments, the digital lock 104 may retrieve data from a server or multiple servers via an Internet connection instead of or in addition to the memory 128. The server or servers may be the same server or servers in communication with the digital key 102.

In some embodiments, the digital lock 104 may function in conjunction with mechanical locks, keypads, proximity readers, biometric scanners, quick response (QR) code scanners, and/or the like that have functionality irrespective of interaction with the digital key 102 and/or as an additional layer of security. In some embodiments, the digital lock 104 may be a part of a double-sided lock system. The double-sided lock system may include a first lock and a second lock on an opposite side of the first lock to control access from two opposite directions. One or both of the first lock and the second lock may be the digital lock 104. The first lock and the second lock may have different entry requirements. For example, the first lock may not require the digital key 102 while the second lock may require the digital key 102 to be locked and/or unlocked.

In some embodiments, the digital lock 104 may have an input/output device. The input/output device may have some or all specifications of the input/output device 120 of the electronic device 106, which will be further discussed in greater detail. For example, the input/output device may provide a notification regarding whether the digital lock 104 is in a locked state or an unlocked state and that access was granted or denied upon an unlocking attempt. In another example, the notification may be a confirmation that the digital lock 104 was successfully locked. The notification maybe visual, auditory, or haptic. The input aspect of the input/output device may be utilized to control the digital lock 104 through visual (e.g., a still image, a moving image), auditory (e.g., voice command), or motion input (e.g., waving, walking by).

The electronic device 106 may be a wearable device. For example, the electronic device 106 may be worn on a wrist of the user 201 as shown in FIG. 2. In other examples, the electronic device 106 may be worn on a finger, an arm, the chest, or the neck of the user 201. The electronic device 106 may be worn on other suitable parts of the body that allow for detection of at least one vital sign. The electronic device 106 may be or integrated with a smartwatch, an arm band, a chest band, a necklace, by example. In some embodiments, the electronic device 106 may not be directly fastened to the body of the user 201 but may contact the skin of the user 201 to detect at least one vital sign. The electronic device 106 may detect vital signs using an indirect contact method such as radar, camera, etc. within the proximity of the user 201. The electronic device 106 may include a sensor 114, a memory 116, a wireless transceiver 118, an input/output device 120, and a processor 122.

The sensor 114 may detect one or more vital signs of the user 201 (see FIG. 2) in real time. In some embodiments, there may be a plurality of sensors, each detecting one or more vital signs. For example, the sensor 114 may detect a pulse rate, a respiration rate, and/or a body temperature of the user 201. The sensor 114 or the sensors may be an optical heart rate sensor, a pulse oximeter or an SpO₂ sensor, a bioimpedance sensor, an electrocardiogram (ECG) sensor, a skin temperature sensor, or any other sensor capable of detecting a vital sign. The optical heart rate sensor may detect pulse and measure heart beats per minute. The SpO₂ sensor may measure blood oxygen levels. The bioimpedance sensor may measure a variety of metrics, including heart rate, respiration rate, and water level. The ECG sensor may detect the minute electrical impulse produced by the heart. The skin temperature sensor may measure body temperature and detect changes in body temperature. The sensor 114 failing to detect pulse or minute electrical impulse produced by the heart may indicate that the electronic device 106 is either not being worn or properly worn, or that the heart of the user 201 has stopped beating. Similarly, the sensor 114 not being able to detect a body temperature or measuring an abnormally low body temperature may indicate that the electronic device 106 is either not being worn or properly worn, or that the heart of the user 201 has stopped beating, respectively.

The memory 116 may be a random-access memory (RAM), a disk, a flash memory, optical disk drives, hybrid memory, or any other store medium that can store data. The memory 116 may store program code that is executable by the processor 122. The memory 116 may store data in an encrypted or any other suitable secure form. In some embodiments, the electronic device 106 may retrieve data from a server or multiple servers via an Internet connection instead of or in addition to the memory 116. The server or servers may be the same server or servers in communication with the digital key 102 and/or the digital lock 104.

The memory 116 may store one or more reference vital signs of the user 201 (see FIG. 2). A reference vital sign may be measured by the sensor 114 during an initial configuration or calibration process. In some embodiments, the reference vital sign may be measured by the sensor 114 over a predetermined period of time measured in hours, days, weeks, months, etc. An average of the measurements obtained during the predetermined period of time may be calculated by the processor 122 to yield the reference vital sign. In some embodiments, the processor 122 may produce a range of values based on the measurements obtained during the predetermined period of time to determine reference vital signs. For example, the range of values may be between the lowest and highest vital sign values measured during the predetermined period of time. In some embodiments, the range of values may include the lowest and highest vital sign values measured during the predetermined period of time. In some embodiments, the user 201 may manually input a reference vital sign or vital signs into the electronic device 106. For example, the user 201 may measure a vital sign using an external device, which may be a medical device, or generally know his/her vital sign values from monitoring them through the course of his/her life. The reference vital sign or vital signs may be then stored in the memory 116.

The memory 116 may store the measured vital signs of the user 201. For example, the memory 116 may store a database of all vital sign measurements for the user 201 to date. In another example, the memory 116 may store the vital sign measurements for the user 201 that go back to a predetermined time. For instance, the memory 116 may store the most recent vital sign measurements for the electronic device 106 to monitor and detect acceptable changes in vital signs of the user 201 that may be due to physical activity (e.g., a workout, a cardiovascular exercise, etc.). The most recent vital sign measurements may go back to several seconds or several minutes, by example.

The wireless transceiver 118 may wirelessly exchange information with the digital key 102. The wireless transceiver 118 may include but is not limited to a Bluetooth®, an IR, an RF, an UWB, or a WiFi® based communication hardware. In some embodiments, some or all of the aforementioned communication methods may be available for selection of the user 201 (see FIG. 2) based on preference or suitability (e.g., signal travel distance, signal availability, signal interference, signal travel speed, etc.). The wireless transceiver 118 may utilize another wireless communication technology appreciated by one of ordinary skill in the art.

The input/output device 120 may receive visual, auditory, and/or touch input. For example, the input/output device 120 may include a camera, a microphone, a touchscreen, a button, and/or a remote. The user 201 (see FIG. 2) may input commands and information into the input/output device 120 to operate the electronic device 106. For example, the input/output device 120 may receive biometric information, voice command, and/or touch input with one or more fingers. The input/output device 120 may further output information, such as notifications, through visual, auditory, and/or haptic means. For example, the input/output device 120 may include a display, which may be a touchscreen display, a speaker, and/or a vibration motor. The user 201 may receive information visually through the display, auditorily through the speaker, and/or haptically through the vibration motor.

The display of the input/output device 120 may be a liquid crystal display (LCD), a light-emitting diode display (LED), an organic light emitting diode (OLED), a plasma display, a cathode-ray tube (CRT) display, a digital light processing display (DLPT), a microdisplay, a projection display, or any other display appreciated by one of ordinary skill in the art. The display may display user interfaces, text, images, and/or the like.

The processor 122 may be configured to execute machine-readable instructions. In some embodiments, there may be one or more processors or microprocessors. In some embodiments, the processor 122 may be a part of a controller or a microcontroller comprising one or more integrated circuits configured to control and manage operations of the electronic device 106. The processor 122 may be coupled to or in electronic communication with the sensor 114, the memory 116, the wireless transceiver 118, and the input/output device 120.

The processor 122 may receive a vital sign measurement or detection from the sensor 114. The processor 122 may compare the vital sign measurement to the reference vital sign stored in the memory 116. If the vital sign is within a threshold of similarity to the reference vital sign, the processor 122 may prompt the wireless transceiver 118 to send a signal to or communicate with the digital key 102 to activate the digital key 102. In embodiments where multiple vital signs are measured, all or some measured vital signs may have to be within a threshold of similarity to their respective reference vital signs in order for the digital key 102 to be activated. Alternatively, only one measured vital sign of all measured vital signs may have to be within a threshold of similarity to its respective vital sign in order for the digital key 102 to be activated. The user 201 (see FIG. 2) may choose between these options based on the desired level of security to be in place.

The threshold of similarity may be predetermined by the processor 122 or selected and inputted by the user 201 (see FIG. 2). The threshold of similarity may be a percentage (e.g., 1%, 2%, 5%, 10%, or 15%, etc.) or a plus or minus numeric value (e.g., 0.5, 1, 5, etc.). For example, the measured vital sign value may be within a reference vital sign range or outside the reference vital sign range by 2% or 5 degrees Fahrenheit or beats per minute. The processor 122 may also monitor patterns on how vital signs are changing over time to compensate for shifting in the measured vital sign value due to physical activity. If the vital sign value is not within a threshold of similarity to the reference vital sign, the processor 112 may prompt the wireless transceiver 118 to send a signal to or communicate with the digital key 102 to deactivate the digital key 102. Similarly, if no vital sign is detected or measured, such as no pulse, the processor 112 may prompt the wireless transceiver 118 to send a signal to or communicate with the digital key 102 to deactivate the digital key 102. In some embodiments, only an activation signal may be communicated to the digital key 102 if the previously discussed requirements are met, and the digital key 102 may otherwise remain deactivated. If the digital key 102 ceases to receive a periodic activation signal (measured in seconds or minutes by example), the digital key 102 may switch to a deactivated state.

The activation and deactivation signals may be received by the wireless transceiver 110 of the digital key 102. The processor 112 of the digital key 102, which may be coupled to or in electronic communication with the wireless transceiver 110, may recognize the activation and deactivation signals and enable and disable the wireless transceiver 110, respectively. Once enabled, the wireless transceiver 110 may communicate with the digital lock 104 to unlock and lock the digital lock 104. The communication may be received by the wireless transceiver 124 of the digital lock 104. The processor 126 of the digital lock 104, which may be coupled to or in electronic communication with the wireless transceiver 124, may then mechanically actuate the digital lock 104 to lock or unlock based on user input or the state of the digital lock 104. For example, the user 201 (see FIG. 2) may select to lock the digital lock 104 via an input/output device of the digital key 102. In another example, the digital lock 104 may be unlocked if the digital lock 104 is in a locked state or locked if it is in an unlocked state. In some embodiments, activation of the digital key 102 may not be required to lock the digital lock 104.

FIG. 2 shows a user 201 interacting with a digital security system 200 of a vehicle 208. The digital security system 200 may include a digital key 202, a digital lock 204, and an electronic device 206. The digital key 202 may have the same specifications of the digital key 102 (see FIG. 1) and embodied in a smartphone. The digital lock 204 may have the same specifications of the digital lock 104 (see FIG. 1) and embodied in a vehicle lock. The vehicle lock may secure various parts of the vehicle 208 such as doors, a trunk, a tailgate, and a gas filling compartment. The vehicle lock may also prevent the ignition or the power of the vehicle 208 from being switched between on and off positions without the digital key 202. The electronic device 206 may have the same specifications of the electronic device 106 (see FIG. 1) and embodied in a wearable, particularly a smartwatch.

The vehicle 208 is a conveyance capable of transporting a person, an object, or a permanently or temporarily affixed apparatus. The vehicle 208 may have an automatic or manual transmission. The vehicle 208 may be a self-propelled wheeled conveyance, such as a car, an SUV, a truck, a bus, a van or other motor or battery driven vehicle. For example, the vehicle 208 may be an electric vehicle, a hybrid vehicle, a plug-in hybrid vehicle, a fuel cell vehicle, or any other type of vehicle that includes a motor/generator. The vehicle 208 may be an autonomous or semi-autonomous vehicle having self-driving capabilities.

The electronic device 206 may detect or measure one or more vital signs of the user 201 in real time. The vital sign may be, for example, a pulse rate, a respiration rate, or a body temperature of the user 201. The electronic device 206 may compare the measured vital sign or vital signs to their respective reference vital signs stored in the electronic device 206. The electronic device 206 may communicate with the digital key 202 to activate the digital key 202 when the measured vital sign or vital signs are within a threshold of similarity to their respective reference vital sign or vital signs. Conversely, the electronic device 206 may communicate with the digital key 202 to deactivate the digital key 202 when the measured vital sign or vital signs are either not measured or detected or not within a threshold of similarity to their respective reference vital sign or vital signs. In some embodiments, only an activation signal may be communicated to the digital key 202 if the previously discussed requirements are met, and the digital key 202 may otherwise remain deactivated. If the digital key 202 ceases to receive a periodic activation signal (measured in seconds or minutes by example), the digital key 202 may switch to a deactivated state.

Once the digital key 202 is activated, the digital key 202 may unlock and lock the digital lock 204. In some embodiments, the digital key 202 may have to be activated only to unlock the digital lock 204. For example, the digital key 202 may unlock a door 210 of the vehicle 208. In another example, the digital key 202 may start an engine or an electric motor of the vehicle 208. If the digital key 202 is deactivated, the engine or the electric motor may shut off. If the vehicle 208 is an autonomous or a semi-autonomous vehicle, the vehicle 208 may automatically pull over and safely shut off the engine or the electric motor when the digital key 202 is deactivated.

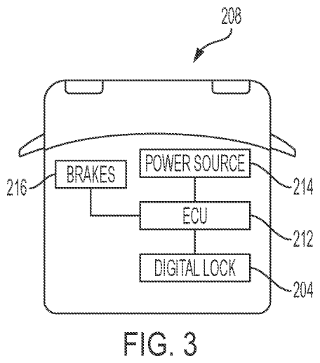

FIG. 3 shows a schematic view of the vehicle 208. The vehicle 208 may include an electronic control unit (ECU) 212, a power source 214, and brakes 216. The power source 214, the brakes 216, and the digital lock 204 may each be coupled to or in electronic communication with the ECU 212.

In some embodiments, the vehicle 208 may have one or more ECUs 212. The ECU 212 may be programmed to control one or more operations of the vehicle 208. The ECU 212 may be electronically coupled to some or all of the components of the vehicle 208. In some embodiments, the ECU 212 may be a central ECU configured to control one or more operations of the entire vehicle 208. In some embodiments, the ECU 212 may be multiple ECUs located within the vehicle 208 and each configured to control one or more local operations of the vehicle 208. Multiple ECUs 212 may communicate with each other via a controller area network (CAN bus) system or another conventional vehicle communication system. In some embodiments, the ECU 212 may be one or more computer processors or controllers configured to execute instructions stored in a non-transitory memory.

The power source 214 may be a gasoline engine, a hybrid engine, a diesel engine, an electric motor, or a fuel cell. The power source 214 provide power to various electrical and mechanical components of the vehicle 208 and propel the vehicle 208. The ECU 212 may control the power source 214 to be turned on and off. If the digital key 202 is deactivated due to an unrecognized vital sign or an undetected vital sign, the ECU 212 may turn off a running power source 214 or prevent the digital key 202 from interacting with the digital lock 204 to turn on the power source 214. The deactivation of the digital key 202 may be communicated to a wireless transceiver of the digital lock 204 or the vehicle 208. In some embodiments where the vehicle 208 is an autonomous or a semi-autonomous vehicle, the ECU 212 may control the power source 214 and the brakes 216 to steer, accelerate, and deaccelerate the vehicle 208 based on sensor readings (e.g., lidar, radar, sonar, inertial navigation systems (IMUs), cameras, etc.). If the digital key 202 is activated, the ECU 212 may commence driving the vehicle 208 to a desired destination once the digital key 202 interacts with the digital lock 204. If the digital key 202 is deactivated while the vehicle 208 is moving or stopped with the power source 214 turned on due to an unrecognized vital sign or an undetected vital sign, the ECU 212 may prevent manual steering, acceleration, and deacceleration of the vehicle 208. Then, the ECU 212 may control the power source 214 and the brakes 216 to safely pull over the vehicle 208. Thereafter, the ECU 212 may turn off or disable the power source 214. As such, if the electronic device 106 changes possession without the consent of the user 201 or the user 201 becomes incapacitated, hence resulting in abnormal or no vital sign detection, the vehicle 208 may be safely taken off the road while in an operational state.

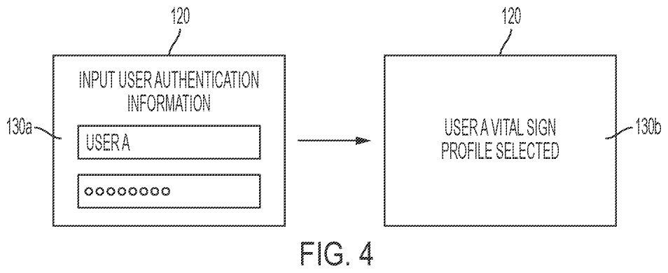

FIG. 4 shows a schematic view of the input/output device 120 of the electronic device 106 (see FIG. 1) of the digital security system 100 (see FIG. 1). The input/output device 120 may be embodied in a display as shown in FIG. 4. The input/output device 120 may display a user interface. For example, the input/output device 120 may display screens 130a,b as shown in FIG. 4. In screen 130a, user authentication information is requested. The user authentication information may be requested or prompted by the processor 122 (see FIG. 1) of the electronic device 106. The user authentication information may be an added layer of security to the digital security system 100. In some embodiments, the user authentication information may be shared with the digital key 102 (see FIG. 1). The input/output device 111 (see FIG. 1) may display screens 130a,b as shown in FIG. 4, and the digital key 102 may manage the user authentication information instead of the electronic device 106. The user authentication information may include a username, a password, a passcode, a pattern, and/or biometric information (e.g., face scan, fingerprint, etc.). In FIG. 4, a combination of a username and a passcode are requested, by example.

The user authentication information may be prompted every time the electronic device 106 is worn or attempted to be used by the user 201 (see FIG. 2). In some embodiments, the user authentication information may be prompted after the lapse of a predetermined time period (e.g., thirty (30) seconds, five (5) minutes, thirty (30) minutes, etc.) since the last authenticated use of the electronic device 106 or since the last time the electronic device 106 was unworn. Once the user authentication information is verified, continuous user verification with minimal or no latency may be carried out via vital sign verification.

The user authentication information may be associated with user identification data of a particular user of the electronic device 106 (see FIG. 1). The user identification data may include a first name, a last name, a username, an alias, a nickname, an account number, an email address, a birth date, a social security number, a security code and/or the like. The user identification data may be stored in the memory 116 (see FIG. 1), the memory 108, or a server. Distinct user profiles may be formed based on the user identification data. One or more reference vital signs for a particular user may be identified based on the user identification data. In other words, the one or more reference vital signs may each be associated with a user profile. For example, once the user authentication information is inputted for “User A” as shown on the screen 130a, the processor 122 (see FIG. 1) may match the user authentication information with the user identification data or the user profile of User A and find the reference vital sign or vital signs associated with the user profile of User A as shown on the screen 130b. Thereafter, any vital sign measurement may be compared to the reference vital sign of User A. Hence, multiple users who have registered with the electronic device 106, such that user authentication information, user identification data, and reference vital sign or vital signs exist for each of the multiple users, may each use the electronic device 106 to activate the digital key 102 (see FIG. 1) to unlock and lock the digital lock 104 (see FIG. 1).

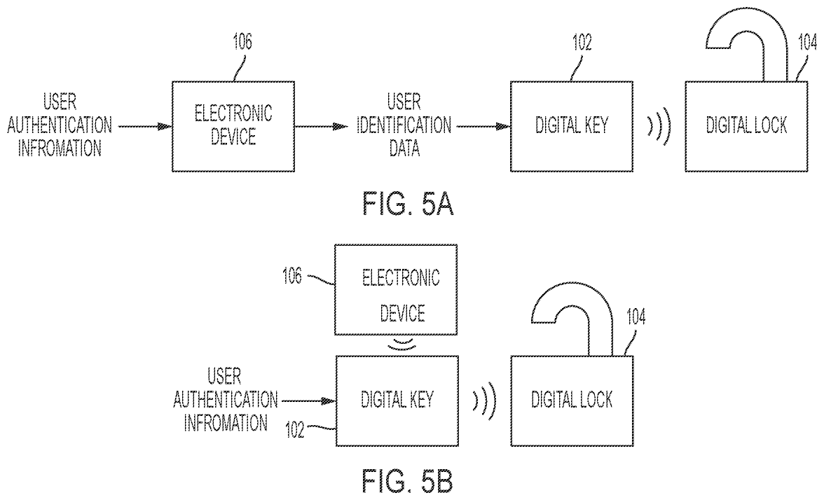

FIG. 5A shows a schematic view of an example user authentication process of the digital security system 100 (see FIG. 1). The electronic device 106 may receive user authentication information via the input/output device 120 (see FIG. 1). The processor 122 (see FIG. 1) of the electronic device 106 may match the received user authentication information with user identification data stored in the memory 116 (see FIG. 1) of the electronic device 106 or a server if the user authentication information is verified by the processor 122. The matched user identification data may be transmitted to the digital key 102 via the wireless transceiver 118 (see FIG. 1) of the electronic device 106. The wireless transceiver 110 (see FIG. 1) of the digital key 102 may receive the user identification data. The processor 112 (see FIG. 1) of the digital key 102 may verify the user identification data by comparing the user identification data to a reference user identification data stored in the memory 108 (see FIG. 1) of the digital key 102. Only once the user identification data is verified, the electronic device 106 may be able to activate the digital key 102 by the vital sign verification process. The verification of the user identification data may be performed each time the electronic device 106 is worn, turned on, or unlocked. After the user identification data verification is complete, the digital key 102 may be activated by the electronic device 106 by real time vital sign verification with minimal or no latency.

FIG. 5B shows a schematic view of another example user authentication process of the digital security system 100 (see FIG. 1). The digital key 102 may receive user authentication information via a native or external input/output device. The processor 112 (see FIG. 1) of the digital key 102 may verify the received user authentication information with the user authentication information stored in the memory 108 (see FIG. 1) of the digital key 102 or a server. Only once the user authentication information is verified, the electronic device 106 may be able to activate the digital key 102 by the vital sign verification process. The verification of the user authentication information may be performed each time the digital key 102 is used, turned on, or unlocked. After the user authentication information verification is complete, the digital key 102 may be activated by the electronic device 106 by real time vital sign verification with minimal or no latency.

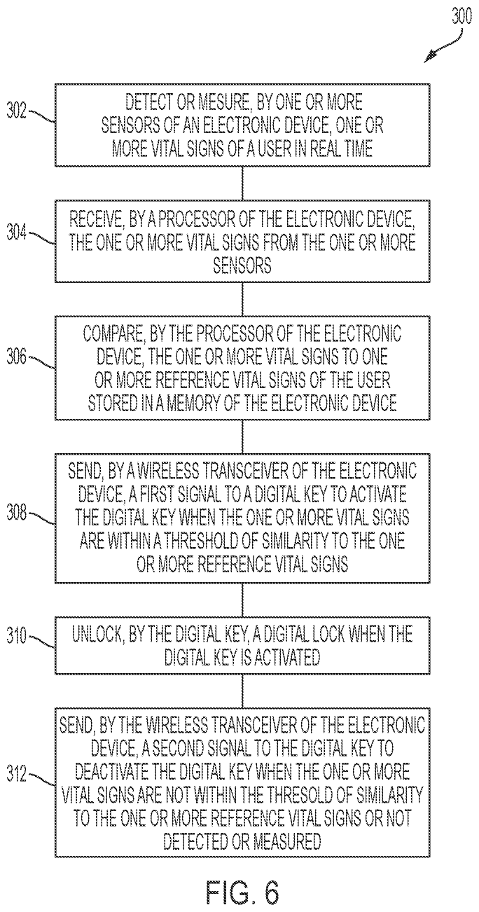

FIG. 6 shows a flowchart of a method 300 for operating the digital security system 100 (see FIG. 1). The method 300 may be carried out with the digital key 102 (see FIG. 1), the digital lock 104 (see FIG. 1), and the electronic device 106 (see FIG. 1). The method 300 may commence with block 302.

In block 302, one or more sensors 114 (see FIG. 1) of the electronic device 106 may detect or measure one or more vital signs of the user 201 (see FIG. 2) in real time. Each sensor 114 may detect or measure a single vital sign or a plurality of vital signs. For example, the sensor 114 may detect a pulse rate, a respiration rate, and/or a body temperature of the user 201. The sensor 114 or the sensors may be an optical hear rate sensor, a pulse oximeter or an SpO₂ sensor, a bioimpedance sensor, an electrocardiogram (ECG) sensor, a skin temperature sensor, or any other sensor capable of detecting a vital sign.

In block 304, the processor 122 (see FIG. 1) of the electronic device 106 may receive the one or more vital signs from the one or more sensors 114. The processor 122 and the one or more sensors 114 may be coupled or in electronic communication.

In block 306, the processor 122 of the electronic device 106 may compare the one or more vital sings to one or more reference vital signs of the user 201 stored in the memory 116 of the electronic device 106. The comparison may include determining whether a vital sign is within a threshold of similarity (e.g., within about 1%, 2%, 5%, 10%, or 15%, etc.) to a reference vital sign. In embodiments where multiple vital signs are measured, all or some measured vital signs may be compared to determine if they are within a threshold of similarity to their respective reference vital signs. In some embodiments, a reference vital sign may be measured by a sensor 114 over a predetermined period of time. An average of the measurements obtained during the predetermined period of time may be calculated by the processor 122 to yield the reference vital sign. In some embodiments, the processor 122 may produce a range of values based on the measurements obtained during the predetermined period of time to determine reference vital signs. In some embodiments, the range of values may include the lowest and highest vital sign values measured during the predetermined period of time. In some embodiments, the user 201 (see FIG. 2) may manually input a reference vital sign or vital signs into the electronic device 106. The threshold of similarity may be predetermined by the processor 122 or selected and inputted by the user 201.

In block 308, the wireless transceiver 118 (see FIG. 1) of the electronic device 106 may send a first signal to or communicate with the digital key 102 to activate the digital key 102 when the one or more vital signs are within a threshold of similarity to the one or more reference vital signs. The first signal or the communication may be received by the wireless transceiver 110 (see FIG. 1) of the digital key 102. The processor 112 (see FIG. 1) of the digital key 102, which may be coupled to or in electronic communication with the wireless transceiver 110, may recognize the activation signal and enable the wireless transceiver 110 to interact with the digital lock 104. In embodiments where multiple vital signs are measured, all or some measured vital signs may have to be within a threshold of similarity to their respective reference vital signs in order for the digital key 102 to be activated. Alternatively, only one measured vital sign of all measured vital signs may have to be within a threshold of similarity to its respective vital sign in order for the digital key 102 to be activated. The user 201 may choose between these options based on the desired level of security to be in place.

In block 310, the digital key 102 may unlock the digital lock 104. The digital key 102 may have to be activated in order for the digital key 102 to unlock the digital lock 104. The communication may be received by the wireless transceiver 124 (see FIG. 1) of the digital lock 104. The processor 126 (see FIG. 1) of the digital lock 104, which may be coupled to or in electronic communication with the wireless transceiver 124, may then mechanically actuate the digital lock 104 to unlock the digital lock 104.

In block 312, the wireless transceiver 118 of the electronic device 106 may send a second signal to or communicate with the digital key 102 to deactivate the digital key 102 when the one or more vital signs are not within the threshold of similarity to the one or more reference vital signs or not detected or measured. The second signal or the communication may be received by the wireless transceiver 110 of the digital key 102. The processor 112 of the digital key 102 may recognize the deactivation signal and prevent the wireless transceiver 110 of the digital key 102 from interacting with the digital lock 104 to unlock or lock the digital lock 104. The method 300 may conclude with block 312.

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A digital security system, comprising:
a digital key configured to lock and unlock a digital lock when activated; and
an electronic device comprising:
one or more sensors configured to detect or measure one or more vital signs of a user in real time,
a memory configured to store one or more reference vital signs of the user,
a wireless transceiver configured to communicate with the digital key, and
a processor coupled to the one or more sensors, the memory, and the wireless transceiver and configured to receive the one or more vital signs from the one or more sensors, compare the one or more vital signs to the one or more reference vital signs and prompt the wireless transceiver to send a signal to the digital key to activate the digital key when the one or more vital signs are within a threshold of similarity to the one or more reference vital signs and deactivate the digital key when the one or more vital signs are not within the threshold of similarity to the one or more reference vital signs or not detected or measured.

2. The digital security system of claim 1, wherein the digital lock is a lock of a vehicle that locks and unlocks one or more doors of the vehicle and enables a power source of the vehicle to supply power to the vehicle when activated.

3. The digital security system of claim 2, wherein the power source is disabled when the digital key is deactivated.

4. The digital security system of claim 2, wherein the vehicle is an autonomous vehicle having an electronic control unit (ECU) configured to automatically control the power source and brakes of the vehicle to pull over the vehicle and disable the power source once the vehicle is pulled over when the digital key is deactivated.

5. The digital security system of claim 1, wherein the processor is further configured to prompt user authentication information and choose the reference one or more vital signs from the memory to compare to the one or more vital signs based on user identification data stored in the memory associated with the user authentication information.

6. The digital security system of claim 5, wherein the wireless transceiver is further configured to transmit the user identification data to the digital key, and a processor of the digital key is configured to verify the user identification data by comparing the user identification data to a reference user identification data stored in a memory of the digital key prior to the digital key unlocking the digital lock.

7. The digital security system of claim 1, wherein a processor of the digital key is configured to prompt and verify user authentication information prior to the digital key unlocking the digital lock.

8. A digital security system for a vehicle, comprising:
a digital key configured to lock and unlock a digital lock of one or more doors of the vehicle and enable a power source of the vehicle to supply power to the vehicle when activated and disable the power source when deactivated; and
a wearable electronic device comprising:
one or more sensors configured to detect or measure one or more vital signs of a user in real time,
a memory configured to store one or more reference vital signs of the user,
a wireless transceiver configured to communicate with the digital key, and
a processor coupled to the one or more sensors, the memory, and the wireless transceiver and configured to receive the one or more vital signs from the one or more sensors, compare the one or more vital signs to the one or more reference vital signs and prompt the wireless transceiver to send a signal to the digital key to activate the digital key when the one or more vital signs are within a threshold of similarity to the one or more reference vital signs and deactivate the digital key when the one or more vital signs are not within the threshold of similarity to the one or more reference vital signs or not detected or measured.

9. The digital security system of claim 8, wherein the one or more vital signs of the user include a pulse rate, a respiration rate, or a body temperature.

10. The digital security system of claim 8, wherein the wearable electronic device is configured to be worn on a wrist of the user.

11. The digital security system of claim 8, wherein the vehicle is an autonomous vehicle having an electronic control unit (ECU) configured to automatically control the power source and brakes of the vehicle to pull over the vehicle and disable the power source once the vehicle is pulled over when the digital key is deactivated.

12. The digital security system of claim 8, wherein the processor is further configured to prompt user authentication information and choose the reference one or more vital signs from the memory to compare to the one or more vital signs based on user identification data stored in the memory associated with the user authentication information.

13. The digital security system of claim 12, wherein the wireless transceiver is further configured to transmit the user identification data to the digital key, and a processor of the digital key is configured to verify the user identification data by comparing the user identification data to a reference user identification data stored in a memory of the digital key prior to the digital key unlocking the digital lock.

14. The digital security system of claim 8, wherein the digital key includes a processor configured to prompt and verify user authentication information prior to the digital key unlocking the digital lock.

15. A method for operating a digital security system, comprising:
detecting or measuring, by one or more sensors of an electronic device, one or more vital signs of a user in real time;
receiving, by a processor of the electronic device, the one or more vital signs from the one or more sensors;
comparing, by the processor of the electronic device, the one or more vital signs to one or more reference vital signs of the user stored in a memory of the electronic device;
sending, by a wireless transceiver of the electronic device, a first signal to a digital key to activate the digital key when the one or more vital signs are within a threshold of similarity to the one or more reference vital signs;
unlocking, by the digital key, a digital lock when the digital key is activated; and
sending, by the wireless transceiver of the electronic device, a second signal to the digital key to deactivate the digital key when the one or more vital signs are not within the threshold of similarity to the one or more reference vital signs or not detected or measured.

16. The method of claim 15, wherein the digital lock is a lock of a vehicle that locks and unlocks one or more doors of the vehicle, further comprising enabling, by an electronic control unit (ECU) of the vehicle, a power source of the vehicle to supply power to the vehicle when the digital lock is activated and disabling, by the ECU of the vehicle, the power source when the digital key is deactivated.

17. The method of claim 16, wherein the vehicle is an autonomous vehicle, further comprising automatically controlling, by the ECU of the vehicle, the power source and brakes of the vehicle to pull over the vehicle when the digital key is deactivated and disabling, by the ECU of the vehicle, the power source once the vehicle is pulled over.

18. The method of claim 15, further comprising prompting, by the processor of the electronic device, user authentication information and choosing, by the processor of the electronic device, the reference one or more vital signs from the memory of the electronic device to compare the one or more vital signs based on user identification data stored in the memory associated with the user authentication information.

19. The method of claim 18, further comprising transmitting, by the wireless transceiver of the electronic device, the user identification data to the digital key and verifying, by a processor of the digital key, the user identification data by comparing the user identification data to a reference user identification data stored in a memory of the digital key prior to the digital key unlocking the digital lock.

20. The method of claim 15, further comprising prompting, by a processor of the digital key, user authentication information and verifying, by the processor of the digital key, the user authentication information prior to the digital key unlocking the digital lock.
